(19) United States
(12) Patent Application Publication
(10) Pub. No.: US 2025/0305502 A1
(43) Pub. Date: Oct. 2, 2025

(54) MOTOR PUMP

(71) Applicant: EBARA CORPORATION, Tokyo (JP)

(72) Inventors: Toshiharu NAKAZAWA, Tokyo (JP); Kozo MATAKE, Tokyo (JP); Yohei OISHI, Tokyo (JP); Takayuki KURONUMA, Tokyo (JP)

(21) Appl. No.: 18/556,870

(22) PCT Filed: Apr. 26, 2021
(86) PCT No.: PCT/JP2021/016614

§ 371 Date: Apr. 16, 2024

(51) Int. Cl. F04D 13/06; H02K 1/14; H02K 1/16; H02K 1/27; H02K 3/34; H02K 5/20; H02K 7/08

(52) U.S. Cl. CPC F04D 13/06; H02K 1/146; H02K 1/165; H02K 1/27; H02K 3/345; H02K 5/203; H02K 7/085

(57) ABSTRACT

The invention is applicable to a motor pump. The motor pump (MP) includes an impeller (1), a pump casing (2), a motor stator (6), a motor casing (3), a heat radiation member (20), and a substrate (50) arranged in an accommodation space (SP).

### TECHNICAL FIELD

The present invention relates to a motor pump.

### BACKGROUND ART

A pump apparatus is known that include a motor and a pump coupled by a coupling. The pump apparatus has a structure that transmits a driving force of the motor to an impeller of the pump via the coupling.

### CITATION LIST

### Patent Literature

Patent document 1: Japanese laid-open patent publication No. 2011-106323
Patent document 2: Japanese laid-open patent publication No. 2016-169734
Patent document 3: Japanese laid-open patent publication No. 2019-143521

### SUMMARY OF INVENTION

### Technical Problem

However, in such a pump apparatus, the pump and the motor are arranged side by side, resulting in a large footprint. On the other hand, a demand for compactness has been increasing in recent years, and as a result, a demand for the pump and the motor with an integrated structure is also increasing. Furthermore, a demand is also increasing for the pump apparatus that is low-cost, energy-efficient, and capable of stable operation.

Therefore, the present invention provides a motor pump having features that meet demand expectations.

### Solution to Problem

In an embodiment, there is provided a motor pump, comprising: an impeller accommodating a permanent magnet; a pump casing accommodating the impeller; a motor stator having a plurality of stator coils; a motor casing accommodating the motor stator; a heat radiation member closing an accommodation space formed in the motor casing; and a substrate connected to the stator coils and arranged in the accommodation space.

In an embodiment, the substrate is arranged radially outside a suction port coupled to a liquid flow channel formed in the motor casing.

In an embodiment, the substrate is covered with a potting material filled in the accommodation space.

In an embodiment, the potting material is filled in the accommodation space, forming a gap adjacent to the heat radiation member.

In an embodiment, there is provided a motor pump, comprising: an impeller accommodating a permanent magnet; a pump casing accommodating the impeller; and a motor casing accommodating a motor stator, the impeller comprises: a magnet accommodation portion accommodating the permanent magnet; a side plate closing an open end of the magnet accommodation portion; and a main plate connected to the side plate.

In an embodiment, the side plate has a side-plate side welded portion that is ultrasonically welded to the magnet accommodation portion, and the main plate has a main-plate side welded portion that is ultrasonically welded to the side plate.

In an embodiment, there is provided a motor pump, comprising: an impeller accommodating a permanent magnet; a pump casing accommodating the impeller; a motor casing accommodating a motor stator; and a bearing rotatably supporting the impeller, the bearing comprises a stationary side bearing body having an inclined surface arranged opposite to a side surface of a rotary side bearing body fixed to the impeller.

In an embodiment, the inclined surface is a thrust surface supporting a thrust load of the impeller, and has a tapered shape that narrows toward the side surface of the rotary side bearing body.

In an embodiment, there is provided a motor pump, comprising: an impeller accommodating a permanent magnet; a pump casing accommodating the impeller; a motor stator comprising a stator core; and a motor casing accommodating the motor stator, the stator core is a pressed iron core integrally composed of a teeth portion and a yoke portion.

In an embodiment, there is provided a motor pump, comprising: an impeller accommodating a permanent magnet; a pump casing accommodating the impeller; a motor stator; and a motor casing accommodating the motor stator, the motor stator comprises: a stator core having a plurality of teeth portions; a plurality of stator coils wound around each of the teeth portions; and an insulating coating portion covering a contact portion of the stator core with the stator coil.

In an embodiment, the teeth portion has: an inner portion arranged on an inner circumference side of the stator core; and an outer portion arranged on an outer circumference side of the stator core, a thickness of the insulating coating portion covering the outer portion is thicker than a thickness of the insulating coating portion covering the inner portion.

In an embodiment, the outer portion has a wide portion that extends from the inner circumference side to the outer circumference side of the stator core, and the insulating coating portion has a thick portion covering the wide portion.

In an embodiment, there is provided a motor pump, comprising: an impeller accommodating a permanent magnet; a pump casing accommodating the impeller; a motor stator comprising a stator core having a plurality of teeth portions; and a motor casing accommodating the motor stator, the teeth portion has an inner portion arranged on an inner circumference side of the stator core, and the inner portion has a flat surface extending in a straight line.

### Advantageous Effects of Invention

Since the motor pump includes a substrate arranged in an accommodation space, a space required to draw stator coils can be reduced. As a result, the motor pump can be made more compact and meet demand expectations.

### BRIEF DESCRIPTION OF DRAWINGS

FIG. 1 is a view showing one embodiment of a motor pump;

FIG. 2 is a view showing one embodiment of a substrate;

FIG. 3A is a view showing a process of filling an accommodation space of a motor casing with a potting material;

FIG. 3B is a view showing the process of filling the accommodation space of the motor casing with the potting material;

FIG. 4 is a view showing the substrate in contact with an inner surface of a heat radiation member;

FIG. 5 is a view showing one embodiment of an impeller;

FIG. 6A is a view of a magnet accommodation portion viewed from a direction of an axis;

FIG. 6B is a longitudinal cross-sectional view of the magnet accommodation portion;

FIG. 7 is a view of a side plate viewed from the direction of the axis;

FIG. 8 is a view of a main plate viewed from the direction of the axis;

FIG. 9 is a view showing the magnet accommodation portion, the side plate, and the main plate fixed to each other;

FIG. 10 is a view showing one embodiment of a bearing;

FIG. 11 is a view showing a spiral groove formed on a side surface of a rotary side bearing body;

FIG. 12 is a view of a stator core of a motor stator viewed from the direction of the axis;

FIG. 13 is a sectional view taken along a line A-A in FIG. 12;

FIG. 14 is an enlarged view of a teeth portion;

FIG. 15 is a view showing a stator coil;

FIG. 16 is a view showing another embodiment of the stator core.

### DESCRIPTION OF EMBODIMENTS

Hereinafter, embodiments of the motor pump will be described with reference to the drawings. In the following embodiments, the same or corresponding components are given the same reference numerals and redundant explanations will be omitted.

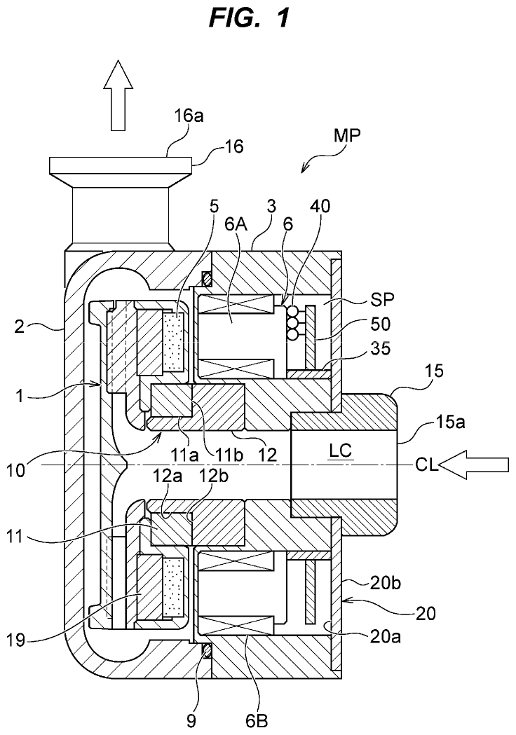

FIG. 1 is a view showing one embodiment of a motor pump. In the embodiments shown below, the motor pump MP has several features that meet demand expectations. As shown in FIG. 1, the motor pump MP includes an impeller 1 that accommodates a permanent magnet 5, a motor stator 6 that generates a magnetic force acting on the permanent magnet 5, a pump casing 2 that accommodates the impeller 1, a motor casing 3 that accommodates the motor stator 6, and a bearing 10 that supports a radial load and a thrust load of the impeller 1. The motor stator 6 and the bearing 10 are arranged on a suction side of the impeller 1.

The pump casing 2 and the motor casing 3 are coupled to each other by a plurality of coupling bolts (not shown). A sealing member (e.g., an O ring) 9 is arranged between the pump casing 2 and the motor casing 3 to prevent liquid leakage.

The impeller 1 and the motor casing 3 face each other through a small gap, and the impeller 1 rotates when a rotating magnetic field generated by the motor stator 6 acts on the permanent magnet 5.

In this embodiment, the permanent magnet 5 is a single annular permanent magnet with a plurality of magnetized poles, but a plurality of permanent magnets 5 may be provided. The motor pump MP further includes an annular magnet yoke 19 (magnetic material) arranged adjacent to the permanent magnet 5. The permanent magnet 5 is arranged on the suction side of the magnet yoke 19.

The impeller 1 is rotatably supported by a single bearing 10. The bearing 10 is a sliding bearing (dynamic pressure bearing) that utilizes a dynamic pressure of a liquid. The bearing 10 includes a rotary side bearing body 11 fixed to the impeller 1 and a stationary side bearing body 12 fixed to the motor casing 3. The rotary side bearing body 11 is arranged so as to surround a liquid inlet of the impeller 1. The stationary side bearing body 12 is arranged on the suction side of the rotary side bearing body 11. The stationary side bearing body 12 has a radial surface 12a that supports the radial load of the impeller 1, and a thrust surface 12b that supports the thrust load of the impeller 1. The radial surface 12a extends parallel to a direction of an axis CL (i.e., an axis of the impeller 1) of the motor pump MP, and the thrust surface 12b extends perpendicularly to the direction of the axis CL.

The rotary side bearing body 11 has an annular shape. An inner circumferential surface 11a of the rotary side bearing body 11 faces a radial surface 12a of the stationary side bearing body 12, and a side surface 11b of the rotary side bearing body 11 faces the thrust surface 12b of the stationary side bearing body 12.

The motor pump MP includes a suction port 15 fixed to the motor casing 3 and having a suction inlet 15a. A liquid flow channel LC is formed in centers of the suction port 15, the motor casing 3, and the bearing 10. The liquid flow channel LC extends parallel to the direction of the axis CL of the motor pump MP, and constitutes one flow channel extending from the suction port 15a to the liquid inlet of the impeller 1.

The motor pump MP includes a discharge port 16 fixed to the pump casing 2 and having a discharge outlet 16a. The liquid pressurized by the rotating impeller 1 is discharged to an outside of the motor pump MP through the discharge outlet 16a. The discharge outlet 16a is arranged on a radially outward of the impeller 1, and the suction inlet 15a is arranged in a direction perpendicular to a radial direction of the impeller 1 (i.e., in the direction of the axis CL). In this manner, the motor pump MP in which the suction inlet 15a and the discharge outlet 16a are orthogonal is a so-called end-top type motor pump.

As shown in FIG. 1, the motor stator 6 includes a stator core 6A having an annular shape and a plurality of stator coils 6B wound around the stator core 6A. The motor casing 3 has an accommodation space SP having an annular concave structure formed therein, and the motor stator 6 is accommodated in the accommodation space SP. The accommodation space SP is arranged radially outward of the suction port 15 coupled to the liquid flow channel LC. By accommodating the motor stator 6 in the accommodation space SP, the motor stator 6 is arranged concentrically with the liquid flow channel LC. In one embodiment, the stator core 6A may be composed of a plurality of members arranged in an annular shape.

In the stator coil 6B, extension portions of the windings from the stator coil 6B are respectively connected to a substrate 50, and a wiring pattern for driving the stator coils 6B is printed on the substrate 50. A lead wire 40 is further connected to the substrate 50, and is connected to an external power source (not shown) of the motor pump MP. The substrate 50 is arranged in the accommodation space SP of the motor casing 3 so as to be arranged concentrically with the liquid flow channel LC.

According to the present embodiment, the motor pump MP includes the substrate 50 arranged in the accommodation space SP of the motor casing 3, so that a compact structure can be realized. Generally, it is necessary to connect the stator coil 6B of the motor stator 6 to the power source. Normally, it is necessary to insulate the stator coils 6B with a glass tube or the like, and then connect the stator coils 6B to each other by means such as soldering or welding.

With such a configuration, it is necessary to secure a space necessary for routing the stator coil 6B, and as a result, a size of the motor pump may be increased. Furthermore, the operator is required to perform complicated wiring work for the stator coil 6B, and there is a risk of erroneous wiring.

In this embodiment, the motor pump MP includes the substrate 50, and an operator can assemble the motor pump MP by simply connecting the lead wires 40 to the substrate 50. As a result, the operator can shorten an assembly work time of the motor pump MP, and furthermore, it is possible to reduce mistakes in wiring work.

As shown in FIG. 1, the accommodation space SP is closed by a heat radiation member 20. The heat radiation member 20 is arranged between the motor casing 3 and the suction port 15, and is used as a motor cover that closes the accommodation space SP. In one embodiment, the heat radiation member 20 may be made of a material that has a higher thermal conductivity than the motor casing 3. Such materials are, for example, metals such as stainless steel or aluminum, or ceramics.

The motor pump MP includes a heat transfer ring 35 arranged between the heat radiation member 20 and the stator core 6A of the motor stator 6. The heat transfer ring 35 is arranged concentrically with the liquid flow channel LC, and is in contact with both the stator core 6A and the heat radiation member 20. It is preferable that the heat transfer ring 35 is made of the same material as the heat radiation member 20.

The motor stator 6 is a heating element. More specifically, when a current is passed through the stator coil 6B of the motor stator 6, the stator coil 6B generates heat. A part of the heat is transferred to the heat radiation member 20 through the stator core 6A and the heat transfer ring 35. The heat transferred to the heat radiation member 20 is efficiently diffused into the outside air via the heat radiation member 20.

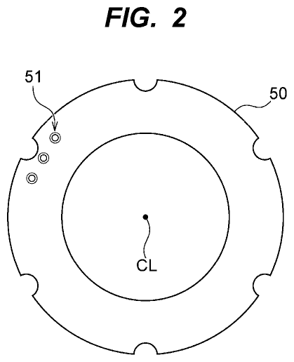

FIG. 2 is a view showing one embodiment of the substrate. As shown in FIG. 2, the substrate 50 has a land portion 51 connected to the lead wire 40, and a wiring pattern (not shown) is printed on a surface of the substrate 50. In this embodiment, the substrate 50 has an annular shape and is arranged radially outside the suction port 15. A structure of the substrate 50 is not particularly limited as long as it can be placed in the accommodation space SP. In one embodiment, the substrate 50 may have a C shape, may have a semicircular shape, or may be composed of a plurality of divided bodies. In other embodiment, the substrate 50 may have a rectangular shape with a size that can be accommodated in the accommodation space SP.

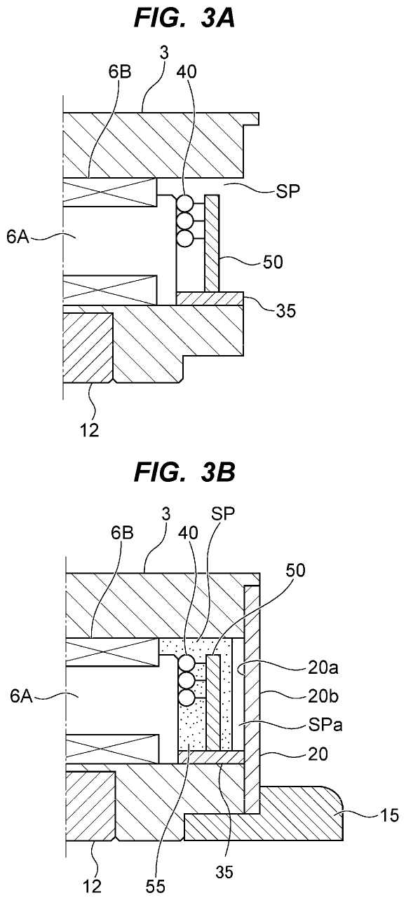

FIGS. 3A and 3B are views showing a process of filling the accommodation space of the motor casing with a potting material. As shown in FIG. 3A, the operator places the substrate 50 and the heat transfer ring 35 to which the substrate 50 is attached in the accommodation space SP. Thereafter, as shown in FIG. 3B, the operator fills the accommodation space SP with a potting material (e.g., silicone resin) 55.

After filling the potting material 55, the operator closes the accommodation space SP with the heat radiation member 20 and attaches the suction port 15 to the motor casing 3. By attaching the suction port 15, the heat radiation member 20 is sandwiched between the motor casing 3 and the suction port 15.

As shown in FIG. 3B, the entire substrate 50 is covered with the potting material 55 filled in the accommodation space SP. The potting material 55 covering the substrate 50 can protect the substrate 50 from liquids such as moisture.

In the embodiment shown in FIG. 3B, a gap SPa is formed between the potting material 55 and an inner surface 20a of the heat radiation member 20. The potting material 55 may expand due to an influence of heat from motor stator 6. By forming the gap SPa, it is possible to prevent the heat radiation member 20 from being deformed or damaged due to expansion of the potting material 55. The heat radiation member 20 has an outer surface 20b arranged on an opposite side of the inner surface 20a, and the outer surface 20b is in contact with the outside air.

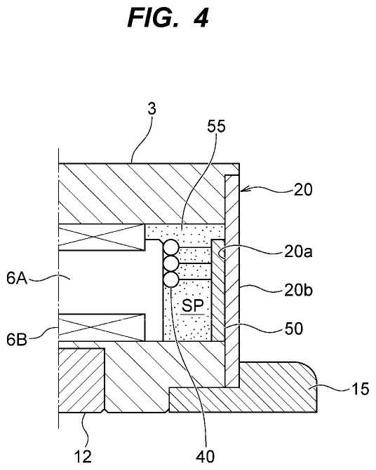

FIG. 4 is a view showing the substrate in contact with the inner surface of the heat radiation member. As shown in FIG. 4, the substrate 50 may contact the inner surface 20a of the heat radiation member 20. In this embodiment, the substrate 50 is arranged in the accommodation space SP in which the motor stator 6, which is a heating element, is accommodated. Therefore, there is a possibility that the substrate 50 is affected by the heat of the motor stator 6. Therefore, by bringing the substrate 50 into contact with the inner surface 20a of the heat radiation member 20, the influence of heat on the substrate 50 is suppressed.

The motor pump MP has the impeller 1 having a characteristic structure in order to meet demand expectations (e.g., stable operation of the motor pump MP, cost reduction of the motor pump MP). Hereinafter, the structure of the impeller 1 will be explained with reference to the drawings.

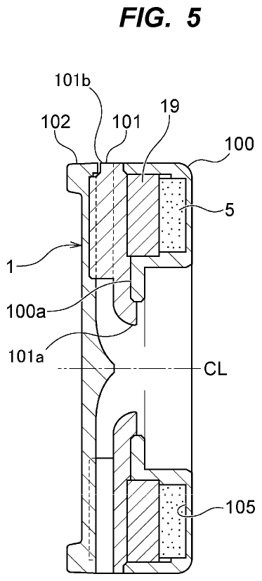

FIG. 5 is a view showing one embodiment of the impeller. In the embodiment shown in FIG. 5, the impeller 1 includes a magnet accommodation portion 100 that accommodates the permanent magnet 5 (and the magnet yoke 19), a side plate 101 that closes an open end 100a of the magnet accommodation portion 100, and a main plate 102 connected to the side plate 101. The impeller 1 is made of a non-magnetic material that is slippery and hard to wear. An example of this material is a resin such as PPS (polyphenylene sulfide).

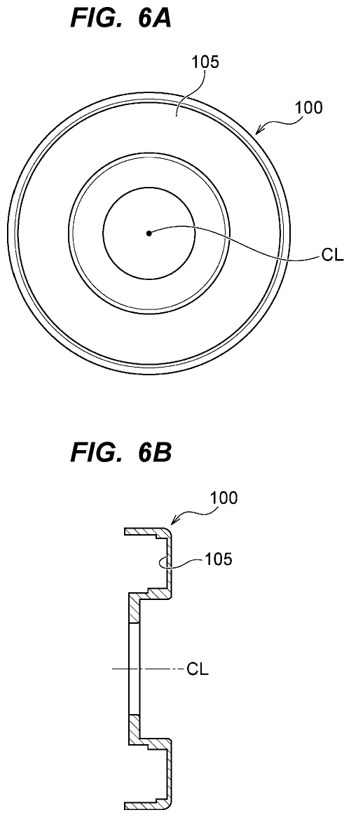

FIG. 6A is a view of the magnet accommodation portion viewed from the direction of the axis. FIG. 6B is a longitudinal cross-sectional view of the magnet accommodation portion. As shown in FIGS. 6A and 6B, the magnet accommodation portion 100 has an annular recess portion 105 having an annular shape, and the permanent magnet 5 and the magnet yoke 19 are attached to the annular recess portion 105.

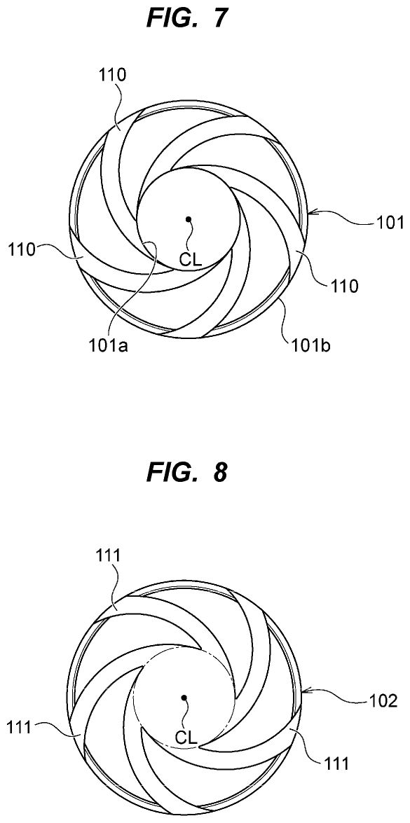

FIG. 7 is a view of the side plate viewed from the direction of the axis. As shown in FIG. 7, the side plate 101 has an annular shape and has a plurality of flow channels 110 extending spirally from an inner circumferential surface 101a of the side plate 101 toward an outer circumferential surface 101b. Each of the plurality of flow channels 110 has a concave shape. The side plate 101 can be attached to the magnet accommodation portion 100. With the permanent magnet 5 and the magnet yoke 19 are attached to the annular recess portion 105 of the magnet accommodation portion 100, the annular recess portion 105 is closed by attaching the side plate 101 to the magnet accommodation portion 100.

FIG. 8 is a view of the main plate viewed from the direction of the axis. As shown in FIG. 8, the main plate 102 has a disk shape and has a plurality of flow channels 111 extending spirally from a center of the main plate 102 toward the outside. Each of the flow channels 111 has a convex shape. The flow channel 111 of the main plate 102 and the flow channel 110 of the side plate 101 correspond to each other, and by attaching the main plate 102 to the side plate 101, the impeller 1 has vanes formed by the flow channels 110 and 111 therein. In other words, the flow channels 110 and 111 constitute a vane by their combination.

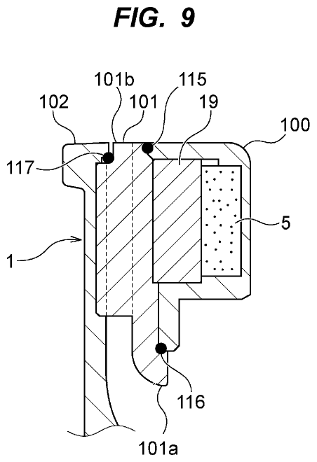

FIG. 9 is a view showing the magnet accommodation portion, the side plate, and the main plate fixed to each other. As shown in FIG. 9, the side plate 101 has a side-plate side welded portions 115 and 116 that are ultrasonically welded to the magnet accommodation portion 100, and the main plate 102 has a main-plate side welded portion 117 that is ultrasonically welded to the side plate 101.

The side-plate side welded portion 115 is arranged on the outer circumferential surface 101b side of the side plate 101, and the side-plate side welded portion 116 is arranged on the inner circumferential surface 101a side of the side plate 101. The impeller 1 has a structure in which the liquid passes through an inside of the impeller 1, and accommodates the permanent magnet 5 and the magnet yoke 19. Therefore, the impeller 1 has a structure that prevents the liquid from entering the magnet accommodation portion 100.

More specifically, the operator vibrates the side-plate side welded portions 115 and 116 of the side plate 101 with ultrasonic waves, melts these welded portions 115 and 116 with frictional heat, and in this state fixes them to the magnet accommodation portion 100. The welded portion 115 is arranged on the radially outer side of the magnet 5 and the magnet yoke 19, and the welded portion 116 is arranged on the radially inner side of the magnet 5 and the magnet yoke 19. Therefore, the impeller 1 can reliably prevent the liquid from entering the magnet accommodation portion 100. In this embodiment, the magnet accommodation portion 100 and the side plate 101 have a structure in which they fit into each other, so that the liquid can be more reliably prevented from entering the magnet accommodation portion 100.

The main-plate side welded portion 117 is arranged on an outer circumference side (i.e., on the outside of the flow channel 111) of the main plate 102. With this arrangement, the main-plate side welded portion 117 does not obstruct the flow of the liquid passing through the flow channels 110 and 111. In this embodiment, the side plate 101 and the main plate 102 have a structure in which they fit into each other.

The motor pump MP has a structure in which the permanent magnet 5 and the magnet yoke 19 are accommodated inside the impeller 1. In this embodiment, the operator installs the permanent magnet 5 and the magnet yoke 19 inside the impeller 1 by assembling the plurality of divided components (i.e., the magnet accommodation portion 100, the side plate 101, and the main plate 102).

Furthermore, according to the present embodiment, even if the components (i.e., the magnet accommodation portion 100, the side plate 101, and the main plate 102) of the impeller 1 are made of a resin such as a PPS, these components can be fixed easily and at low cost. Further, by providing the side-plate side welded portions 115 and 116 on the side plate 101, and the main-plate side welded portion 117 on the main plate 102, the liquid does not obstruct the flow of the liquid while preventing the liquid from entering the magnet 5 and the magnet yoke 19. Therefore, the stable operation of the motor pump MP can be achieved.

The motor pump MP has a bearing 10 having a characteristic structure in order to meet the demand expectations (for example, the stable operation of the motor pump MP). Hereinafter, the structure of the bearing 10 will be explained with reference to the drawings.

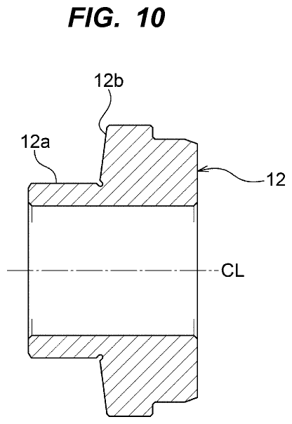

FIG. 10 is a view showing one embodiment of the bearing. As shown in FIG. 10, the bearing 10 includes the stationary side bearing body 12 having an inclined surface arranged opposite to the side surface 11b of the rotary side bearing body 11 fixed to the impeller 1. The inclined surface is the thrust surface 12b that supports the thrust load of the impeller 1. A part of the liquid discharged from the impeller 1 is guided to the bearing 10 through

the small gap between the impeller 1 and the motor casing 3. When the rotary side bearing body 11 rotates together with the impeller 1, a dynamic pressure of the liquid is generated between the rotary side bearing body 11 and the stationary side bearing body 12, and the impeller 1 is supported by the bearing 10 in a non-contact manner. Since the stationary side bearing body 12 supports the rotary side bearing body 11 by the orthogonal radial surface 12a and thrust surface 12b, a tilting movement of the impeller 1 is limited by the bearing 10.

Since the permanent magnet 5 is accommodated in the impeller 1, a magnetic force acts between the permanent magnet 5 and the motor stator 6. More specifically, due to this magnetic force, the side surface 11b of the rotary side bearing body 11 fixed to the impeller 1 moves in a direction approaching the thrust surface 12b of the stationary side bearing body 12. Therefore, when the motor pump MP is started, the rotary side bearing body 11 slides strongly against the stationary side bearing body 12. As a result, the bearing 10 may wear out, and the life of the bearing 10 may be shortened.

Therefore, in order to realize stable operation of the motor pump MP, the thrust surface 12b of the stationary side bearing body 12 has a tapered shape that narrows toward the side surface 11b of the rotary side bearing body 11. In other words, the thrust surface 12b has a tapered shape in which a cross-sectional area of the thrust surface 12b gradually decreases toward the side surface 11b of the rotary side bearing body 11. An inclination angle of the thrust surface 12b is an inclination angle that does not affect the dynamic pressure of the liquid generated between the side surface 11b of the rotary side bearing body 11 and the thrust surface 12b of the stationary side bearing body 12.

According to this embodiment, it is possible to reduce a contact area of the side surface 11b of the rotary side bearing body 11 with the thrust surface 12b of the stationary side bearing body 12, and as a result, when starting the motor pump MP, the frictional force in the bearing 10 caused by the rotation of the impeller 1 can be suppressed. As a result, the life of the bearing 10 can be extended and the stable operation of the motor pump MP can be realized.

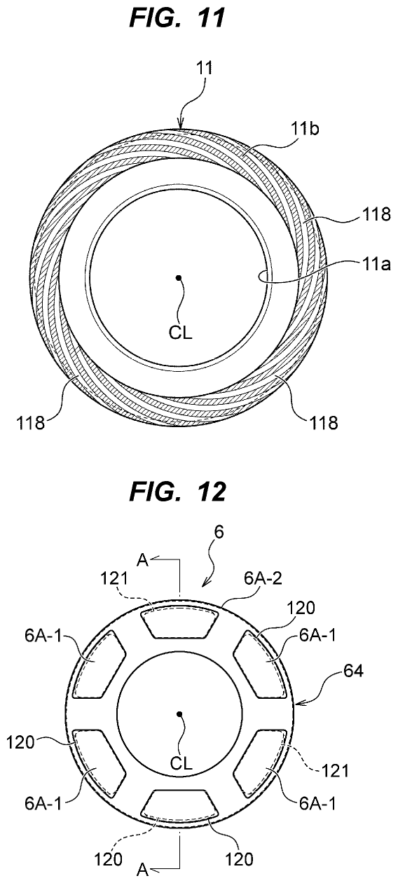

FIG. 11 is a view showing a spiral groove formed on the side surface of the rotary side bearing body. As shown in FIG. 11, the bearing 10 may have a plurality of spiral grooves 118 formed on the side surface 11b of the rotary bearing body 11. Spiral grooves 118 extending in a spiral shape are formed to generate the dynamic pressure by a wedge effect. In the embodiment shown in FIG. 11, the spiral groove 118 is formed on the side surface 11b of the rotary side bearing body 11, but the spiral groove 118 may be formed on the inner circumferential surface 11a of the rotary side bearing body 11. In one embodiment, the spiral groove 118 may be formed on at least one of the radial surface 12a and the thrust surface 12b of the stationary side bearing body 12.

The motor pump MP has the motor stator 6 having a characteristic structure in order to meet demand expectations (for example, cost reduction of the motor pump MP). Hereinafter, the structure of the motor stator 6 will be explained with reference to the drawings.

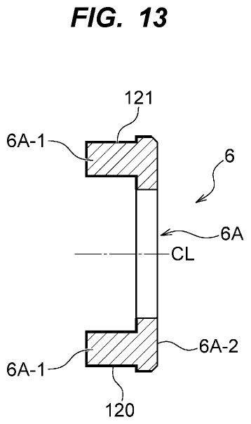

FIG. 12 is a view of the stator core of the motor stator viewed from the direction of the axis. FIG. 13 is a sectional view taken along a line A-A in FIG. 12. As shown in FIGS. 12 and 13, the stator core 6A of the motor stator 6 includes a plurality of teeth portions 6A-1, a yoke portion 6A-2 having an integrally molded structure with the teeth portions 6A-1. The yoke portion 6A-2 has an annular shape, and the teeth portion 6A-1 extends from the yoke portion 6A-2 in the direction of the axis CL, and is arranged at equal intervals along the circumferential direction of the yoke portion 6A-2.

The stator core 6A is a pressed iron core integrally composed of the teeth portion 6A-1 and the yoke portion 6A-2. According to this embodiment, the stator core 6A is composed of the pressed iron core, thereby reducing a manufacturing cost of the stator core 6A. Generally, when manufacturing a stator core, it is necessary to laminate silicon steel sheets and perform a process of machining the teeth portion from the laminated silicon steel sheets (machining process). However, such a process is complicated. In this embodiment, the stator core 6A as the pressed iron core is manufactured by powder metallurgy. Therefore, the machining process can be omitted, and the manufacturing cost of the stator core 6A can be reduced.

FIG. 13 is a view showing an insulating coating portion that covers a contact portion of the stator core with the stator coil. As shown in FIG. 13, the motor stator 6 includes an insulating coating portion 120 that covers a contact portion 121 of the stator core 6A with the stator coil 6B. The contact portion 121 is an entire tooth portion 6A-1 and a portion of the yoke portion 6A-2, and the insulating coating portion 120 covers the contact portion 121. With such a configuration, the insulating coating portion 120 can ensure insulation of the stator core 6A from the stator coil 6B.

Generally, it is necessary to cover the contact portion 121 of the teeth portion 6A-1 with an insulating paper or apply an insulating coating. However, in this embodiment, since the teeth portion 6A-1 has a structure protruding from the yoke portion 6A-2, it is troublesome to cover the entire contact portion 121 of the teeth portion 6A-1 with the insulating paper. Furthermore, when applying insulation coating, it is necessary to go through a drying process. In this embodiment, the insulating coating portion 120 is a thin film made of resin, and the drying process is not necessary, so that the manufacturing cost of the motor pump MP can be reduced.

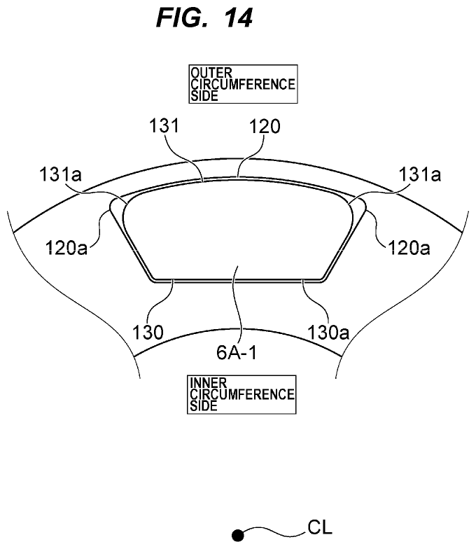

FIG. 14 is an enlarged view of the teeth portion. As shown in FIG. 14, the teeth portion 6A-1 has an inner portion 130 arranged on the inner circumference side of the stator core 6A and an outer portion 131 arranged on the outer circumference side of the stator core 6A. The thickness of the insulating coating portion 120 covering the outer portion 131 is thicker than the thickness of the insulating coating portion 120 covering the inner portion 130. More specifically, the outer portion 131 of the tooth portion 6A-1 has wide portions 131a, 131a that widen from the inner circumference side to the outer circumference side of the stator core 6A. The insulating coating portion 120 has a thick portion 120a that covers the wide portions 131a, 131a.

The thickness of the thick portion 120a of the insulating coating portion 120 that covers the wide portions 131a, 131a is thicker than the thickness of the insulating coating portion 120 that covers other portions of the teeth portion 6A-1. In other words, the curvature of the thick portion 120a is greater than the curvature of the wide portion 131a. A radius of curvature of the thick portion 120a is smaller than the radius of curvature of the wide portion 131a.

If the curvature of the wide portion 131a is increased, there is a risk that the wide portion 131a may be chipped. In particular, when the stator core 6A is composed of a pressed iron core, there is a high possibility that the wide portion 131a will be chipped. As a result, the manufacturing cost of the motor pump MP increases, making it impossible to reduce the cost of the motor pump MP. If the curvature of the thick portion 120a is reduced, a fluidity of the resin constituting the insulation coating portion 120 to the teeth portion 6A-1 may deteriorate in the process of coating the teeth portion 6A-1 with the insulation coating portion 120. In this case, the stator core 6A cannot ensure insulation from the stator coil 6B, and as a result, the manufacturing cost of the motor pump MP increases.

According to this embodiment, the motor stator 6 has a wide portion 131a having a first curvature and a thick portion 120a having a second curvature larger than the first curvature. Therefore, the manufacturing cost of the motor stator 6 can be reduced, and as a result, the cost of the motor pump MP can be reduced.

In order to reduce the manufacturing cost of the motor stator 6, the inner portion 130 of the teeth portion 6A-1 has a flat surface 130a that extends linearly in the direction of the axis CL. The flat surface 130a extends linearly along the direction of the axis CL (see FIG. 14).

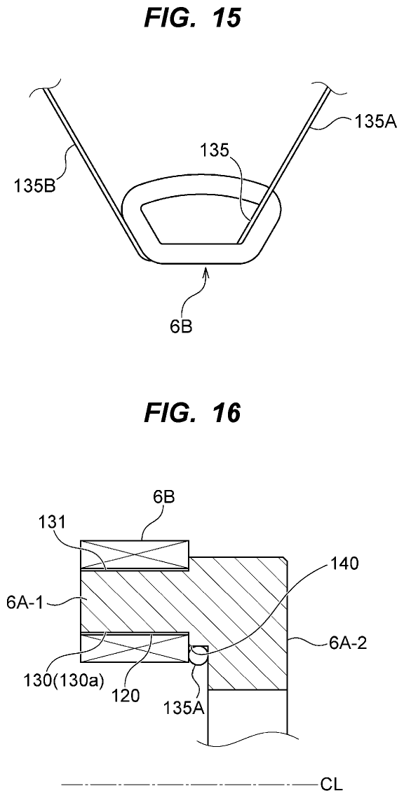

FIG. 15 is a view showing the stator coil. As shown in FIG. 15, the stator coil 6B is manufactured by winding a wire rod (wire wound) 135 in multiple layers around the teeth portion 6A-1 of the stator core 6A so that no gap is created between the teeth portion 6A-1 and the stator coil 6B. In FIG. 15, the wire rod 135 at a beginning of winding is a beginning wire rod 135A, and the wire rod 135 at an end of winding is an ending wire rod 135B. The beginning wire rod 135A and the ending wire rod 135B are each connected to the substrate 50.

For example, when the inner portion 130 has an arcuate surface concave toward the outer portion 131, it is necessary to perform a process of forming a surface of the stator coil 6B corresponding to the arcuate surface of the inner portion 130 into an arc shape (arc formation process). However, by adding such a process, the manufacturing cost of the motor stator 6 cannot be reduced, and as a result, the cost of the motor pump MP cannot be reduced. Therefore, by forming the flat surface 130a on the inner portion 130 of the teeth portion 6A-1, there is no need to perform the arc formation process, and the manufacturing cost of the motor stator 6 can be reduced.

FIG. 16 is a view showing another embodiment of the stator core. As shown in FIG. 16, the stator core 6A has an accommodation step portion 140 formed between the teeth portion 6A-1 and the yoke portion 6A-2. The beginning wire rod 135A is arranged in the accommodation step portion 140. In the embodiment shown in FIG. 16, the accommodation step portion 140 has an annular shape, and has a size that can accommodate the beginning wire rod 135A. In one embodiment, the accommodation step portion 140 does not necessarily have to have an annular shape as long as it can accommodate the beginning wire rod 135A. The number of accommodation step portions 140 may correspond to the number of beginning wire rods 135A of the stator coil 6B.

By forming such the accommodation step portion 140, even when the motor stator 6 is attached to the motor casing 3, a breakage of the beginning wire rod 135A due to adhesion of the beginning wire rod 135A to the yoke portion 6A-2 is prevented. As a result, the stable operation of the motor pump MP can be realized.

In the embodiment described above, the motor pump MP has multiple features that meet demand expectations. These multiple features may be combined as appropriate, and the motor pump MP may have one of these multiple features. In one embodiment, the motor pump MP may include the substrate 50 arranged in the accommodation space SP as an above feature. In one embodiment, the motor pump MP may include the impeller 1 comprising a plurality of components as the above features. In one embodiment, the motor pump MP may include the bearing 10 having an inclined thrust surface 12b as a feature above. In one embodiment, the motor pump MP may include the stator core 6A comprising the pressed iron core as the feature above. In one embodiment, the motor pump MP may include the motor stator 6 with the insulating coating portion as the feature above. In one embodiment, the motor pump MP may include the teeth portion 6A-1 having the flat surface 130a as a feature above.

Although the embodiments of the present invention have been described so far, the present invention is not limited to the above-described embodiments, and it goes without saying that the present invention may be implemented in various different forms within the scope of its technical idea.

### INDUSTRIAL APPLICABILITY

The invention is applicable to a motor pump.

### REFERENCE SIGNS LIST

1 impeller
2 pump casing
3 motor casing
5 permanent magnet
6 motor stator
6A stator core
6A-1 teeth portion
6A-2 yoke portion
6B stator coil
9 sealing member
10 bearing
11 rotary side bearing body
11a inner circumferential surface
11b side surface
12 stationary side bearing body
12a radial surface
12b thrust surface
15 suction port
15a suction inlet
16 discharge port
16a discharge outlet
19 magnet yoke
20 heat radiation member
20a inner surface
20b outer surface
35 heat transfer ring
40 lead wire
50 substrate
51 land portion
55 potting material
100 magnet accommodation portion
100a open end
101 side plate
101a inner circumferential surface
101b outer circumferential surface
102 main plate
105 annular recess portion
110 flow channel
111 flow channel
115,116 side-plate side welded portion
117 main-plate side welded portion
118 spiral groove
120 insulating coating portion
120a thick portion
121 contact portion
130 inner portion
130a flat surface
131 outer portion
131a wide portion
135 wire rod
135A beginning wire rod
135B ending wire rod
140 accommodation step portion
MP motor pump
LC liquid flow channel
SP accommodation space

1. A motor pump, comprising:
an impeller accommodating a permanent magnet;
a pump casing accommodating the impeller;
a motor stator having a plurality of stator coils;
a motor casing accommodating the motor stator;
a heat radiation member closing an accommodation space formed in the motor casing; and
a substrate connected to the stator coils and arranged in the accommodation space.

2. The motor pump according to claim 1, wherein the substrate is arranged radially outside a suction port coupled to a liquid flow channel formed in the motor casing.

3. The motor pump according to claim 1, wherein the substrate is covered with a potting material filled in the accommodation space.

4. The motor pump according to claim 3, wherein the potting material is filled in the accommodation space, forming a gap adjacent to the heat radiation member.

5. A motor pump, comprising:
an impeller accommodating a permanent magnet;
a pump casing accommodating the impeller; and
a motor casing accommodating a motor stator,
wherein the impeller comprises:
a magnet accommodation portion accommodating the permanent magnet;
a side plate closing an open end of the magnet accommodation portion; and
a main plate connected to the side plate.

6. The motor pump according to claim 5, wherein the side plate has a side-plate side welded portion that is ultrasonically welded to the magnet accommodation portion, and
wherein the main plate has a main-plate side welded portion that is ultrasonically welded to the side plate.

7. A motor pump, comprising:
an impeller accommodating a permanent magnet;
a pump casing accommodating the impeller;
a motor casing accommodating a motor stator; and
a bearing rotatably supporting the impeller,
wherein the bearing comprises a stationary side bearing body having an inclined surface arranged opposite to a side surface of a rotary side bearing body fixed to the impeller.

8. The motor pump according to claim 7, wherein the inclined surface is a thrust surface supporting a thrust load of the impeller, and has a tapered shape that narrows toward the side surface of the rotary side bearing body.

9. A motor pump, comprising:
an impeller accommodating a permanent magnet;
a pump casing accommodating the impeller;
a motor stator comprising a stator core; and
a motor casing accommodating the motor stator,
wherein the stator core is a pressed iron core integrally composed of a teeth portion and a yoke portion.

10. A motor pump, comprising:
an impeller accommodating a permanent magnet;
a pump casing accommodating the impeller;
a motor stator; and
a motor casing accommodating the motor stator,
wherein the motor stator comprises:
a stator core having a plurality of teeth portions;
a plurality of stator coils wound around each of the teeth portions; and
an insulating coating portion covering a contact portion of the stator core with the stator coil.

11. The motor pump according to claim 10, wherein the teeth portion has:
an inner portion arranged on an inner circumference side of the stator core; and
an outer portion arranged on an outer circumference side of the stator core,
wherein a thickness of the insulating coating portion covering the outer portion is thicker than a thickness of the insulating coating portion covering the inner portion.

12. The motor pump according to claim 11, wherein the outer portion has a wide portion that extends from the inner circumference side to the outer circumference side of the stator core, and
wherein the insulating coating portion has a thick portion covering the wide portion.

13. A motor pump, comprising:
an impeller accommodating a permanent magnet;
a pump casing accommodating the impeller;
a motor stator comprising a stator core having a plurality of teeth portions; and
a motor casing accommodating the motor stator,
wherein the teeth portion has an inner portion arranged on an inner circumference side of the stator core, and
wherein the inner portion has a flat surface extending in a straight line.
